(19) United States
(12) Patent Application Publication
(10) Pub. No.: US 2016/0237925 A1
(43) Pub. Date: Aug. 18, 2016

(54) VEHICLE CONTROL METHOD AND APPARATUS ACCORDING TO TRANSIENT DRIVING CONDITION RECOGNITION

(71) Applicant: Hyundai Motor Company, Seoul (KR)

(72) Inventors: Jin-Woo Lee, Seoul (KR); Buom-Sik Shin, Seongnam-si (KR); Soon-Chan Pyo, Anyang-si (KR)

(73) Assignee: Hyundai Motor Company, Seoul (KR)

(21) Appl. No.: 14/984,819

(22) Filed: Dec. 30, 2015

(30) Foreign Application Priority Data
Feb. 13, 2015 (KR) 10-2015-0022215

(51) Int. Cl. F02D 41/00; F02D 29/02

(52) U.S. Cl. CPC F02D 41/0007; F02D 29/02

(57) ABSTRACT

Disclosed are vehicle control method and apparatus with transient driving condition recognition. The method may include: operating an engine; calculating a first determination reference value according to a first target boost pressure and a first actual boost pressure; determining whether a differential value of the first determination reference value over time is equal to or more than a first predetermined reference value; controlling a vehicle according to a previously stored exhaust gas reduction map if it is determined that the differential value of the first determination reference value over time is equal to or more than the first predetermined reference value (transient driving condition); and controlling the vehicle according to a previously stored fuel efficiency improvement map if it is determined that the differential value of the first determination reference value over time is less than the first predetermined reference value (a steady driving condition).

### CROSS-REFERENCE TO RELATED APPLICATION

The present application claims priority of Korean Patent Application Number 10-2015-0022215 filed on Feb. 13, 2015, the entire contents of which application are incorporated herein for all purposes by this reference.

### BACKGROUND

1. Field of the Invention

The present invention relates to vehicle control method and apparatus according to transient condition recognition, and more particularly, to vehicle control method and apparatus according to transient condition recognition that can control a vehicle by recognizing transient driving condition by the variation rate of deviation of a boost pressure in an input value.

2. Description of Related Art

There are transient driving condition and steady driving condition as driving conditions of a diesel vehicle. The transient driving condition is the condition in which a vehicle speed changes with time while driving, and the steady driving condition is the condition that a vehicle speed according to time is maintained at a constant speed while driving. Among the total driving time, the driving time according to the transient driving condition is shorter than the driving time according to the steady driving time. Further, in the transient driving condition, the exhaust gas is discharged to the relatively large amount compared to the steady driving condition. Therefore, the transient driving condition needs to reduce the exhaust gas and improve acceleration feelings, and the steady driving condition needs to improve fuel efficiency.

As described above, since the transient driving condition and the steady driving condition have different characteristics and requirements, it is necessary to correctly recognize the transient driving condition and the steady driving condition and distinguish the vehicle control in accordance with the conditions.

The recognition model of the transient driving condition and the steady driving condition according to the prior art recognized the transient driving condition and the steady driving condition by the variation rate of opening degrees of an accelerator pedal or engine revolutions in an input value, and according to this, the vehicle was controlled by applying the corrected map. However, in the case that recognized the variation rate of opening degrees of an accelerator pedal or fuel amount as the input value, there was disadvantage in that it was difficult to distinguish between signal in the area of adjusting the opening degrees of an accelerator pedal in order for a driver to maintain a constant vehicle speed and signal in the acceleration area.

Furthermore, in the case that recognized the variation rate of the engine revolutions as the input value, it was easy to distinguish between signal in the area of adjusting the opening degrees of an accelerator pedal in order for a driver to maintain a constant vehicle speed and signal in the acceleration area compared to the case that recognized the variation rate of opening degrees of an accelerator pedal or fuel amount as the input value. But there was disadvantage in that the effective time for recognition was very short, since the area capable of distinguishing the acceleration signal was generated only initially.

The information disclosed in this Background section is only for enhancement of understanding of the general background of the invention and should not be taken as an acknowledgement or any form of suggestion that this information forms the prior art already known to a person skilled in the art.

### SUMMARY

The present invention has been made to solve the above problems and/or other problems. An object of the present invention is to provide vehicle control method and apparatus that can recognize transient driving condition by the variation rate of deviation of a target boost pressure and an actual boost pressure in an input value and control a vehicle according to this.

The vehicle control method according to the transient driving condition recognition in accordance with some aspects of the present invention may include: operating an engine; calculating a first determination reference value according to a first target boost pressure and a first actual boost pressure; determining whether a differential value of the first determination reference value over time is equal to or more than a first predetermined reference value; recognizing it as a transient driving condition if it is determined that the differential value of the first determination reference value over time is equal to or more than the first predetermined reference value and controlling a vehicle according to a previously stored exhaust gas reduction map; and recognizing it as a steady driving condition if it is determined that the differential value of the first determination reference value over time is less than the first predetermined reference value and controlling the vehicle according to a previously stored fuel efficiency improvement map.

The vehicle control method according to the transient driving condition recognition may further include calculating a second determination reference value according to a second target boost pressure and a second actual boost pressure after controlling the vehicle according to the previously stored exhaust gas reduction map.

The vehicle control method according to the transient driving condition recognition may further include determining whether a differential value of the second determination reference value over time is equal to or less than a second predetermined reference value.

The vehicle control method according to the transient driving condition recognition may perform controlling a vehicle according to the previously stored exhaust gas reduction map if it is determined that the differential value of the second determination reference value over time is equal to or less than the second predetermined reference value.

The vehicle control method according to the transient driving condition recognition may further include determining whether the second determination reference value is equal to or less than a third predetermined reference value if it is determined that the differential value of the second determination reference value over time exceeds the second predetermined reference value.

The vehicle control method according to the transient driving condition recognition may perform controlling a vehicle according to the previously stored exhaust gas reduction map if it is determined that the second determination reference value is equal to or less than the third predetermined reference value.

The vehicle control method according to the transient driving condition recognition may perform controlling a vehicle according to the previously stored fuel efficiency improvement map if it is determined that the second determination reference value exceeds the third predetermined reference value.

The vehicle control method according to the transient driving condition recognition may perform calculating the first determination reference value again after controlling a vehicle according to the previously stored fuel efficiency improvement map.

Calculating the first determination reference value according to the first target boost pressure and the first actual boost pressure may include: calculating the first target boost pressure according to an operation of an accelerator pedal; measuring the first actual boost pressure at a boost pressure measurement part; and normalizing a deviation of the first target boost pressure and the first actual boost pressure to calculate the first determination reference value.

Calculating the second determination reference value according to the second target boost pressure and the second actual boost pressure may include: calculating the second target boost pressure according to an operation of an accelerator pedal; measuring the second actual boost pressure at a boost pressure measurement part; and calculating the second determination reference value as a deviation of the second target boost pressure and the second actual boost pressure.

Controlling a vehicle according to the previously stored exhaust gas reduction map may include: retarding main injection timing of an injector according to the previously stored exhaust gas reduction map; and controlling vanes of a variable geometry turbocharger to narrow an area of an exhaust gas passage according to the previously stored exhaust gas reduction map.

Controlling a vehicle according to the previously stored fuel efficiency improvement map include: advancing main injection timing of an injector according to the previously stored fuel efficiency improvement map; and controlling vanes of a variable geometry turbocharger to widen an area of an exhaust gas passage according to the previously stored fuel efficiency improvement map.

A storage media according to an aspect of the present invention may store a program or instructions to perform the vehicle control method according to the transient driving condition recognition.

A vehicle control apparatus according to the transient driving condition recognition in accordance with some aspects of the present invention may include: a storage media storing a program or instructions to perform the vehicle control method; an accelerator pedal operation recognition part recognizing an operation of an accelerator pedal to calculate the first target boost pressure and a second target boost pressure; a boost pressure measurement part measuring the first actual boost pressure or a second actual boost pressure; an injector injecting fuel in a cylinder of an engine; a variable geometry turbocharger capable of broadening or narrowing an area of an exhaust gas passage; and a controller controlling the injector and the variable geometry turbocharger through the vehicle control method according to information recognized at the accelerator pedal operation recognition part and/or measured at the boost pressure measurement part.

According to the present invention as described herein, by using the variation rate of deviation of a target boost pressure and an actual boost pressure as an input value for recognizing the transient driving condition, it is possible to increase the accuracy of the transient driving condition recognition.

Furthermore, by applying different map according to the transient driving condition or the steady driving condition to control a vehicle, it is possible to reduce exhaust gas and improve fuel efficiency.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A and FIG. 1B are a flow chart illustrating an exemplary vehicle control method according to transient driving condition recognition in accordance with the present invention.

FIG. 2 is a block diagram illustrating an exemplary vehicle control apparatus according to transient driving condition recognition in accordance with the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A word and term used in this specification and claim scope should not be limited to a typical or dictionary meaning and be interpreted as the meaning and concept in compliance with the technological thought of this invention based on the principle that an inventor may define the concept of a term properly in order to explain his/her own invention in the best way. Thus, because the exemplary embodiment written in this specification and the configuration illustrated in the drawings are no more than the best desirable embodiment in the present invention and do not represent all of technological thought in the present invention, it should be understood that there can be various equivalents and transformation examples to replace these at the time of this application. In addition, a detailed description about the well known function and configuration which may obscure the gist of the present invention unnecessarily may be omitted. Hereinafter, a desirable exemplary embodiment in the present invention may be described in detail with reference to the attached drawings.

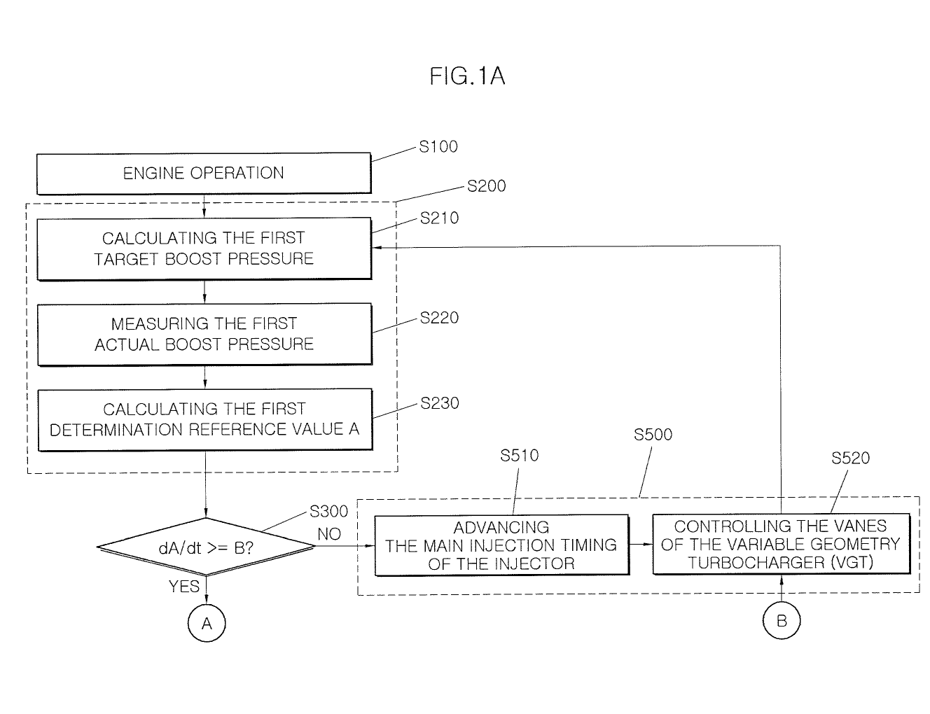

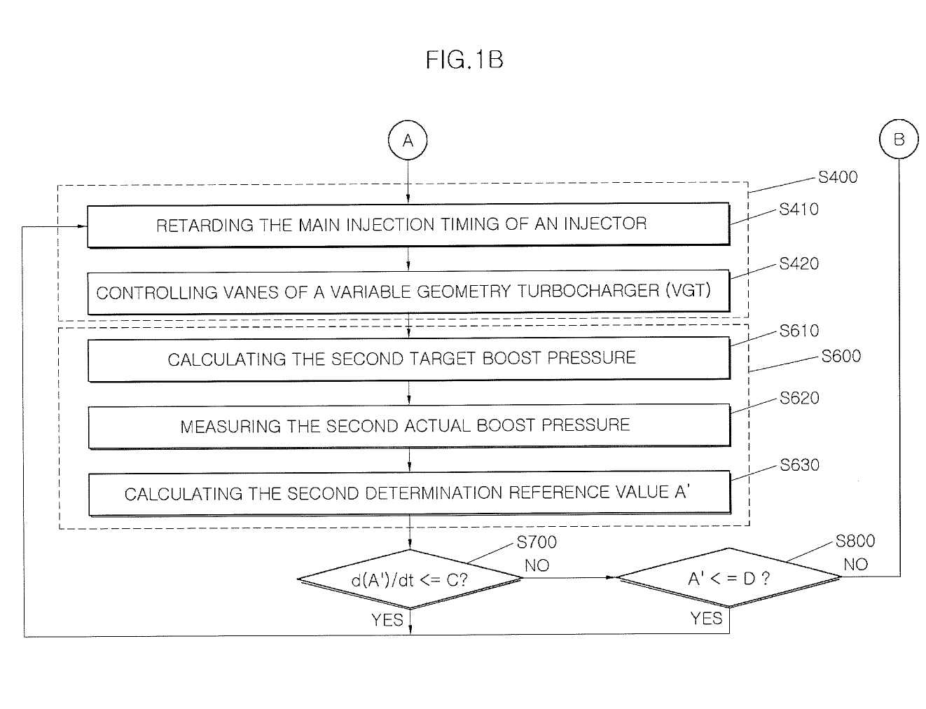

FIGS. 1A and 1B are a flow chart of a vehicle control method according to transient driving condition recognition in accordance with some embodiments of the present invention. Referring to FIGS. 1A and 1B, the vehicle control method according to transient driving condition recognition in accordance with some embodiments of the present invention may include a step of operating an engine (S100); a step of calculating a first determination reference value A according to a first target boost pressure and a first actual boost pressure (S200); a step of determining whether a differential value of the first determination reference value A over time is equal to or more than a first predetermined reference value B (S300); a step of controlling a vehicle according to a previously stored exhaust gas reduction map by recognizing the case that the differential value of the first determination reference value A over time is equal to or more than the first predetermined reference value B as transient driving condition (S400); and a step of controlling a vehicle according to a previously stored fuel efficiency improvement map by recognizing the case that the differential value of the first determination reference value A over time is less than the first predetermined reference value B as steady driving condition (S500).

The step of calculating a first determination reference value A may include a step of calculating the first target boost pressure according to the operation of an accelerator pedal (S210); a step of measuring the first actual boost pressure at a boost pressure measurement part (S220); and a step of normalizing the deviation of the first target boost pressure and the first actual boost pressure to calculate the first determination reference value A (S230). Further, after the step of calculating a first determination reference value A (S200), the step of determining whether a differential value of the first determination reference value A over time is equal to or more than a first predetermined reference value B (S300) may be performed.

Since the recognition model of the transient driving condition and the steady driving condition according to the prior art recognized the transient driving condition and the steady driving condition by the variation rate of opening degrees of an accelerator pedal or engine revolutions in an input value such that the problem as described above occurred, the present invention is to recognize the transient driving condition by the normalized variation rate of deviation (the first determination reference value A) of the target boost pressure and the actual boost pressure in an input value.

The first predetermined reference value B may be set as “1”, but not necessarily limited hereto and can be set differently according to the type of vehicle, and so on.

The step of recognizing the case that the differential value of the first determination reference value A over time is equal to or more than a first predetermined reference value B as transient driving condition and controlling a vehicle according to a previously stored exhaust gas reduction map (S400), may further include a step of retarding the main injection timing of an injector according to the previously stored exhaust gas reduction map (S410); and a step of controlling vanes of a variable geometry turbocharger (VGT) in order to narrow the area of the exhaust gas passage according to the previously stored exhaust gas reduction map (S420). The transient driving condition discharges relatively large amount of exhaust gas compared to the steady driving condition. Therefore, the main injection timing is retarded in order to reduce the exhaust gas. Further, the transient driving condition needs to relatively large amount of air in the engine compared to the steady driving condition. Thus, the vanes of a variable geometry turbocharger (VGT) are controlled in order to narrow the area of the exhaust gas passage, thereby improving the acceleration feelings. The previously stored exhaust gas reduction map is stored to reduce amount of the gas exhausted to atmosphere.

The step of recognizing the case that the differential value of the first determination reference value A over time is less than a first predetermined reference value B as steady driving condition, and controlling a vehicle according to a previously stored fuel efficiency improvement map (S500), may further include a step of advancing the main injection timing of the injector according to the previously stored fuel efficiency improvement map (S510); and a step of controlling the vanes of the variable geometry turbocharger (VGT) in order to widen the area of the exhaust gas passage according to the previously stored fuel efficiency improvement map (S520). The steady driving condition can improve the fuel efficiency other than the transient driving condition. For this, the steady driving condition advances the main injection timing and controls the vanes of the variable geometry turbocharger (VGT) in order for the area of the exhaust gas passage to be widened. The previously stored fuel efficiency improvement map is stored to raise fuel-efficiency of vehicle.

The vehicle control method according to the transient driving condition recognition may further include a step of calculating a second determination reference value A′ according to a second target boost pressure and a second actual boost pressure after the step of controlling a vehicle according to a previously stored exhaust gas reduction map (S400) (S600). Further, the step of calculating the second determination reference value A′ according to the second target boost pressure and the second actual boost pressure (S600) may include a step of calculating the second target boost pressure according to the operation of the accelerator pedal (S610); a step of measuring the second actual boost pressure at the boost pressure measurement part (S620); and a step of calculating the second determination reference value A′ as the deviation of the second target boost pressure and the second actual boost pressure (S630). Since the vehicle is controlled in order for the exhaust gas to be reduced at the step of controlling a vehicle according to a previously stored exhaust gas reduction map (S400), after S400, the target boost pressure (the second target boost pressure) is calculated again, the actual boost pressure (the second actual boost pressure) is measured again and the second determination reference value A′ is calculated again.

The vehicle control method according to the transient driving condition recognition may further include a step of determining whether a differential value of the second determination reference value A′ over time is equal to or less than a second predetermined reference value C (S700). The vehicle control method according to the transient driving condition recognition may perform the step of controlling a vehicle according to a previously stored exhaust gas reduction map (S400) when the differential value of the second determination reference value A′ over time is equal to or less than a second predetermined reference value C. The vehicle control method according to the transient driving condition recognition may recognize the case that the differential value of the second determination reference value A′ over time is equal to or less than the second predetermined reference value C as transient driving condition, and again perform the step of controlling a vehicle according to a previously stored exhaust gas reduction map (S400) in order to reduce the exhaust gas and improve the fuel efficiency. The second predetermined reference value C may be set as “0.01”, but not necessarily limited hereto and can be set differently according to the type of vehicle, and so on.

The vehicle control method according to the transient driving condition recognition may further include a step of determining whether the second determination reference value A′ is equal to or less than a third predetermined reference value D when the differential value of the second determination reference value A′ over time exceeds the second predetermined reference value C (S800). The vehicle control method according to the transient driving condition recognition may perform the step of controlling a vehicle according to a previously stored exhaust gas reduction map (S400) when the second determination reference value A′ is equal to or less than the third predetermined reference value D. The vehicle control method according to the transient driving condition recognition may recognize the case that the second determination reference value A′ is equal to or less than the third predetermined reference value D as transient driving condition, and again perform the step of controlling a vehicle according to a previously stored exhaust gas reduction map (S400) in order to reduce the exhaust gas and improve the fuel efficiency. The third predetermined reference value D may be set as “5 hpa”, but not necessarily limited hereto and can be set differently according to the type of vehicle, and so on.

The vehicle control method according to the transient driving condition recognition may perform the step of controlling a vehicle according to a previously stored fuel efficiency improvement map (S500) when the second determination reference value A′ is more than the third predetermined reference value D. That is, the vehicle control method according to the transient recognition recognizes the case that the second determination reference value A′ is more than the third predetermined reference value D as transient driving condition and performs again the step of controlling a vehicle according to a previously stored fuel efficiency improvement map (S500) in order to improve the fuel efficiency.

The vehicle control method according to the transient driving condition recognition may perform the step of calculating the first determination reference value A (S200) after the step of controlling a vehicle according to a previously stored fuel efficiency improvement map (S500). Since the vehicle is controlled in order for the fuel efficiency to be improved at the step of controlling a vehicle according to a previously stored fuel efficiency improvement map (S500) by recognizing as the steady driving condition, after S500, the target boost pressure (the first target boost pressure) is calculated again, the actual boost pressure (the first actual boost pressure) is measured again and the first determination reference value A′ is calculated again.

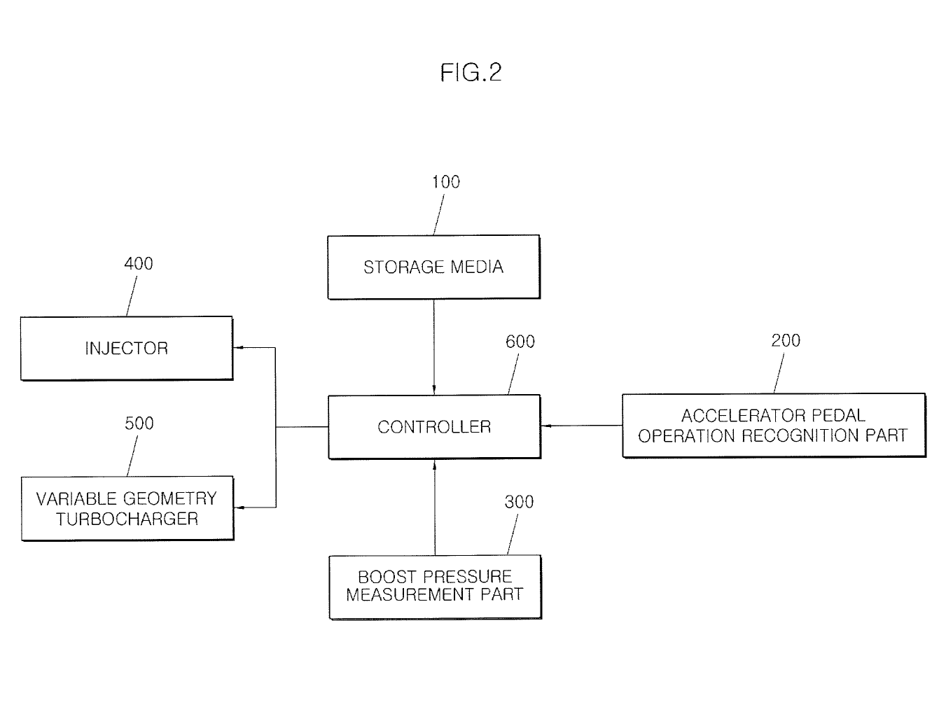

FIG. 2 is a block diagram of a vehicle control apparatus according to transient driving condition recognition in accordance with some embodiments of the present invention. Referring to FIG. 2, the vehicle control apparatus according to transient driving condition recognition in accordance with some embodiments of the present invention may include a storage media 100 in which the vehicle control method (or a program or instructions to perform the method) according to the transient driving condition recognition is stored; an accelerator pedal operation recognition part 200 recognizing the operation of the accelerator pedal in order to calculate the first target boost pressure and the second target boost pressure; a boost pressure measurement part 300 measuring the first actual boost pressure or the second actual boost pressure; an injector 400 injecting fuel into a cylinder of an engine; a variable geometry turbocharger 500 capable of broadening or narrowing an area of exhaust gas passage; and a controller 600 controlling the injector 400 and the variable geometry turbocharger 500 through the vehicle control method according to the transient driving condition recognition stored in the storage media 100 according to the information recognized at the accelerator pedal operation recognition part 200 or measured at the boost pressure measurement part 300.

According to the vehicle control method and apparatus according to transient condition recognition as described herein, it is easy to distinguish between signal in the area of adjusting the opening degrees of an accelerator pedal in order for a driver to maintain a constant vehicle speed and signal in the acceleration area, the effective time for recognition capable of distinguishing acceleration signals can be sufficiently secured. Furthermore, it can be reflected the physical phenomena in the transient driving condition.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vehicle control method comprising:
operating an engine;
calculating a first determination reference value according to a first target boost pressure and a first actual boost pressure;
determining whether a differential value of the first determination reference value over time is equal to or more than a first predetermined reference value;
recognizing it as a transient driving condition if it is determined that the differential value of the first determination reference value over time is equal to or more than the first predetermined reference value and controlling a vehicle according to a previously stored exhaust gas reduction map; and
recognizing it as a steady driving condition if it is determined that the differential value of the first determination reference value over time is less than the first predetermined reference value and controlling the vehicle according to a previously stored fuel efficiency improvement map.

2. The vehicle control method of claim 1, further comprising:
calculating a second determination reference value according to a second target boost pressure and a second actual boost pressure after controlling the vehicle according to the previously stored exhaust gas reduction map.

3. The vehicle control method of claim 2, further comprising:
determining whether a differential value of the second determination reference value over time is equal to or less than a second predetermined reference value.

4. The vehicle control method of claim 3, wherein the controlling of the vehicle according to the previously stored exhaust gas reduction map is performed if it is determined that the differential value of the second determination reference value over time is equal to or less than the second predetermined reference value.

5. The vehicle control method of claim 3, further comprising:
determining whether the second determination reference value is equal to or less than a third predetermined reference value if it is determined that the differential value of the second determination reference value over time exceeds the second predetermined reference value.

6. The vehicle control method of claim 5, wherein the controlling of the vehicle according to the previously stored exhaust gas reduction map is performed if it is determined that the second determination reference value is equal to or less than the third predetermined reference value.

7. The vehicle control method of claim 5, wherein the controlling of the vehicle according to the previously stored fuel efficiency improvement map is performed if it is determined that the second determination reference value exceeds the third predetermined reference value.

8. The vehicle control method of claim 1, wherein the calculating of the first determination reference value is repeated after the controlling of the vehicle according to the previously stored fuel efficiency improvement map.

9. The vehicle control method of claim 1, wherein the calculating of the first determination reference value according to the first target boost pressure and the first actual boost pressure includes:
calculating the first target boost pressure according to an operation of an accelerator pedal;
measuring the first actual boost pressure at a boost pressure measurement part; and
normalizing a deviation of the first target boost pressure and the first actual boost pressure to calculate the first determination reference value.

10. The vehicle control method of claim 2, wherein the calculating of the second determination reference value according to the second target boost pressure and the second actual boost pressure includes:
calculating the second target boost pressure according to an operation of an accelerator pedal;
measuring the second actual boost pressure at a boost pressure measurement part; and
calculating the second determination reference value as a deviation of the second target boost pressure and the second actual boost pressure.

11. The vehicle control method of claim 1, wherein the controlling of the vehicle according to the previously stored exhaust gas reduction map includes:
retarding main injection timing of an injector according to the previously stored exhaust gas reduction map; and
controlling vanes of a variable geometry turbocharger to narrow an area of an exhaust gas passage according to the previously stored exhaust gas reduction map.

12. The vehicle control method of claim 1, wherein the controlling of the vehicle according to the previously stored fuel efficiency improvement map includes:
advancing main injection timing of an injector according to the previously stored fuel efficiency improvement map; and
controlling vanes of a variable geometry turbocharger to widen an area of an exhaust gas passage according to the previously stored fuel efficiency improvement map.

13. A vehicle control apparatus comprising:
a storage media storing a program or instructions to perform the vehicle control method;
an accelerator pedal operation recognition part recognizing an operation of an accelerator pedal to calculate the first target boost pressure and a second target boost pressure;
a boost pressure measurement part measuring the first actual boost pressure or a second actual boost pressure;
an injector injecting fuel in a cylinder of an engine;
a variable geometry turbocharger capable of broadening or narrowing an area of an exhaust gas passage; and
a controller controlling the injector and the variable geometry turbocharger through the vehicle control method according to information recognized at the accelerator pedal operation recognition part and/or measured at the boost pressure measurement part.
